(19) United States
(12) Patent Application Publication
(10) Pub. No.: US 2012/0144832 A1
(43) Pub. Date: Jun. 14, 2012

(54) PASSIVE AIR-FUEL MIXING PRECHAMBER

(75) Inventors: John Thomas Herbon, Rexford, NY (US); Matthew Patrick Boespflug, Clifton Park, NY (US); Grover Andrew Bennett, Schenectady, NY (US); Fengfeng Tao, Clifton Park, NY (US); Giridhar Jothiprasad, Clifton Park, NY (US)

(73) Assignee: GENERAL ELECTRIC COMPANY, Schenectady, NY (US)

(21) Appl. No.: 12/964,836

(22) Filed: Dec. 10, 2010

(51) Int. Cl. F02C 3/14

(52) U.S. Cl. 60/737

(57) ABSTRACT

A gas turbine combustion system passive air-fuel mixing prechamber includes one or more fuel passages. Each fuel passage includes at least one downstream fuel injection orifice. One or more fluid conduits connect an upstream portion of at least one fuel passage with one or more air passages such that pressure drops across each fuel injection orifice substantially self-equalize in a passive manner with corresponding air passage pressure drops over a broad range of fuel lower heating value (LHV) from about 150 Btu/scf to about 900 Btu/scf of fuel passing through the fuel passage while mixing with air passing through one or more connected fluid conduits. The effective area of each fluid conduit relative to the corresponding fuel and air passages is dependent upon the desired fuel LHV operating range.

### STATEMENT REGARDING FEDERALLY SPONSORED RESEARCH & DEVELOPMENT

This invention was made with U.S. Government support under contract number DE-FC26-08NT05868. The Government has certain rights in the invention.

### BACKGROUND

The invention relates generally to gas turbine combustion systems and more particularly to a passive air-fuel mixing prechamber to enable wide fuel flexibility in gas turbine combustion systems.

Fuel flexibility in lean-premixed combustion systems is an important challenge for gas turbines since end users desire to make use of a variety of available fuel sources other than natural gas. These various alternative fuels have different combustion characteristics and may be available in seasonally variable quantities and compositions. A truly fuel flexible combustion system must be able to adapt to these variations, with changes ideally only in the fuel control settings.

Modern gas turbines operating on gaseous fuels, most commonly natural gas, rely on lean-premixed combustion in order to efficiently achieve low NOx emissions levels required by government regulations. The fuel-air premixing process typically occurs inside a premixer located just upstream of the combustion chamber. In the premixer, the fuel is injected into the much larger air flow stream. The fuel injection often occurs as a jet-in-crossflow arrangement; however, many other schemes are also utilized. The fuel mixes in with the air through turbulent structures in the fluid flow.

The premixing process is sensitive to several factors. In the case of jet-in-crossflow mixing, the jet penetration is very sensitive to the momentum flux ratio of the fuel jet relative to the mainstream flow. If the jet momentum flux is too high, the jet overpenetrates through the mainstream flow. This strong jet not only produces a skewed fuel profile in the air passage, but the jet also behaves like a bluff body, generating a strong wake region which can be a potential location for undesirable flameholding inside the premixer. Conversely, if the jet momentum flux is too low, the fuel dribbles out of its hole and does not protrude out into the mainstream flow leading again to a skewed fuel profile. Ultimately, poor premixing leads to regions with fuel/air ratios higher and lower than the mean. High fuel/air ratios will contribute to excessive NOx production and potentially flashback of the flame into the premixer; and low fuel/air ratios can lead to locally extinguished flame fronts.

Fuel-air premixers are designed to work at a specific set of gas turbine conditions and with a specific fuel characteristic. One important fuel characteristic is the lower heating value (LHV), which is equal to the energy content, or heat of reaction, per unit volume of the fuel. As LHV decreases, the gas turbine requires higher volume flow rates of fuel in order to maintain the same power output. However, because of some of the challenges described herein, the premixer is optimized around a specific LHV value and therefore a specific volumetric flow rate. The premixer can operate reasonably well over a narrow range of LHV; however, if the fuel LHV changes more than a few percent, the premixing quality can worsen. In addition, as more volume flow rate is delivered through a fixed orifice, the pressure drop required to drive the fuel injection increases roughly as the square of the volume flow rate. Large changes in fuel pressure drop have been observed to increase sensitivities for certain combustion dynamic tones. Further, increasing fuel pressures will drive additional fuel compression facility requirements and therefore result in additional costs and performance penalties in the system.

Presently, wider fuel flexibility is sometimes achieved through the addition of extra fuel injection circuits. Typically this is required in order to permit the high volumetric flow rates associated with low LHV fuels without simultaneously causing the pressure drop and therefore fuel delivery pressures to increase. Any additional fuel circuits disadvantageously require extra controls for switching between fuels and purging the circuits with air or an inert gas when the circuit is not use. Further, since typical fuel injection strategies are designed around a narrow range of fuels, any additional circuit only adds capability to operate on one additional narrow range of fuels now centered at a different LHV.

In view of the foregoing, it would be advantageous to provide a passive air-fuel mixing prechamber to enable wide fuel-flexibility in gas turbine combustion systems thus providing broader fuel capabilities within a single piece of combustor hardware, moving towards a lean-premixed widely fuel-flexible gas turbine. The prechamber should 1) provide passive compensation within the premixer to adjust and control pressure drops for changes in fuel volumetric flow rate, 2) provide decreased sensitivity of the fuel premixing process to variation in fuel LHV, and 3) provide the ability to optimize premixer (fuel injection) design once for application over a wide range of fuels.

### BRIEF DESCRIPTION

Briefly, in accordance with one embodiment, a passive air-fuel mixing prechamber is provided to enable wide fuel-flexibility in gas turbine combustion systems. The prechamber comprises:

one or more fuel passages, each fuel passage comprising an upstream portion, and further comprising a downstream portion comprising at least one fuel injection orifice; and

one or more fluid conduits, each fluid conduit connecting an upsteam portion fuel passage with one or more air passages such that pressure drops across each fuel injection orifice self-equalize with corresponding air passage pressure drops over a broad range of fuel lower heating value (LHV) from about 150 Btu/scf to about 900 Btu/scf of fuel passing through the fuel passage while mixing with air passing through one or more corresponding fluid conduits.

### DRAWINGS

These and other features, aspects, and advantages of the present invention will become better understood when the following detailed description is read with reference to the accompanying drawings in which like characters represent like parts throughout the drawings, wherein:

FIG. 1 is a simplified diagram illustrating a fuel-flexible premixer with an air-fuel mixing prechamber according to one embodiment;

FIG. 2 is a graph illustrating pressure drop changes across an air-fuel mixing prechamber fuel injection orifice in response to changes in fuel LHV of fuel passing through the fuel injector when using a conventional fuel-air premixer versus a fuel-flexible premixer according to one embodiment;

FIG. 3 is a graph illustrating momentum flux ratio changes through a fuel injection orifice in response to changes in fuel LHV of fuel passing through the fuel injector when using a conventional fuel-air premixer versus a fuel-flexible premixer according to one embodiment;

FIG. 4 is a graph illustrating the experimentally measured premixing profile for a wide range of fuel flow rates, indicating the consistent premixing behavior for fuel volume flow rates ranging more than 8×;

FIG. 5 is a simplified diagram illustrating a fuel-flexible premixer with an air-fuel mixing prechamber according to another embodiment, where the fuel is injected through separate pegs located downstream of the air swirler vanes;

FIG. 6 is a simplified diagram illustrating a fuel-flexible premixer with an air-fuel mixing prechamber according to another embodiment, where the fuel is injected from the trailing edge of the air swirler vanes;

FIG. 7 is a simplified diagram illustrating a fuel-flexible premixer with an air-fuel mixing prechamber according to another embodiment, where the fuel is injected from the centerbody and/or burner tube surfaces, downstream of the air swirler vanes;

FIG. 8 is a diagram illustrating more than one fuel plenum connected to the passive air-fuel mixing prechamber, with each plenum having an appropriately sized pre-orifice such as to cause equal fuel distribution to multiple fuel-air premixing nozzles within a combustion system; and

FIG. 9 is a diagram illustrating the fluid conduits located in a stagnation region of the air flow passage.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

The embodiments described herein function to solve the challenges of fuel-flexible premixing in gas turbine combustion systems by enabling the fuel injection and premixing process to be more consistent over a large range of fuel LHV and therefore fuel volumetric flow rates. In substantially all gas turbine combustion system premixer designs, a pressure drop occurs in the air flow passage, typically across one or more swirlers, vanes, or orifices. The pressure drop across the fuel injection orifices in one design methodology is designed to roughly match the pressure drop on the air side. In this manner, any acoustic perturbations in the combustion system affect both air and fuel flows equally; thus, the fuel/air ratio remains somewhat constant despite the acoustic pressure fluctuations. However, if a new fuel is introduced with a strongly divergent LHV, among other effects the change in fuel injection pressure drop will cause this system to become no longer balanced.

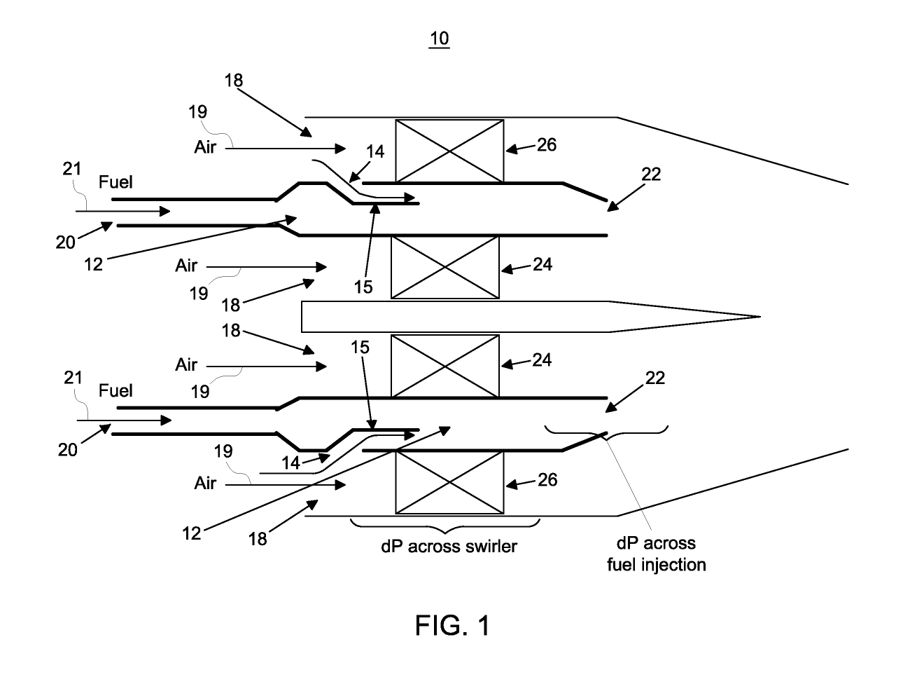

FIG. 1 is a simplified diagram illustrating a fuel-flexible premixer 10 with an air-fuel mixing prechamber 12 according to one embodiment. Prechamber 12 comprises one or more fluid conduits 14 connecting upstream air passages 18 with fuel passages 20 causing the pressures in the air and fuel flows 19, 21 to self-equalize. According to one embodiment, fluid conduits 14 may comprise one or more baffles 15. This process occurs passively. Beginning, for example, at a low value for LHV when the pressures are balanced, as the LHV increases, less fuel flow is required. The pressure drop across the fuel orifices 22 begins to decrease. At this point, the upstream air pressure is higher than the fuel pressure, and air will begin to flow into the prechamber 12 via fluid conduits 14 with the flow rate increasing until the pressure drop is equalized once again. Depending on the effective areas for the fluid interconnects 14 and the effective areas of the air swirlers 24, 26 and fuel orifices 22 this process is able to maintain pressure drops across the corresponding air swirler 24, 26 and corresponding fuel injection orifices 22 that are relatively close to one another across a very broad range of fuel LHV, differing, for example, by no more than about 20% as LHV changes from about 150 Btu/scf to about 900 Btu/scf. The effective area for each fluid interconnect is designed by considering the particular size, shape and geometric features of the corresponding fuel and air passages as well as the desired operating range of fuel LHV. According to one embodiment, the actual pressure drop across the fuel orifices 22 varies only slightly, changing by about 4% to about 50% of the nominal value over the same fuel range, compared to almost a 100-fold change in fuel pressure drop for a typical premixer over this range of fuels.

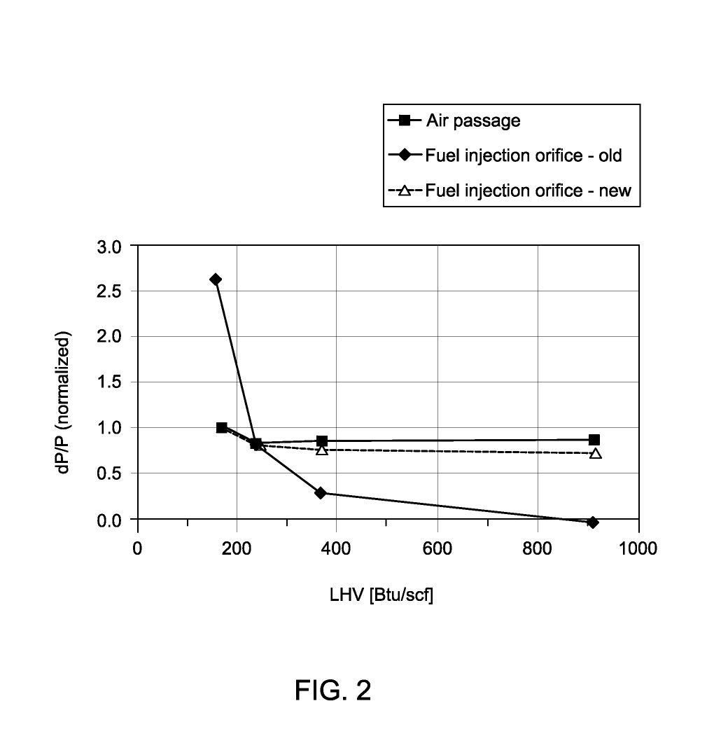

FIG. 2 is a graph illustrating the predicted pressure drop across an air-fuel mixing prechamber fuel injection orifice in response to changes in fuel LHV of fuel passing through the fuel injector when using a conventional fuel-air premixer versus a fuel-flexible premixer according to one embodiment using the principles described herein. These principles can just as easily be applied in a variety of fuel-air premixer geometries, such as the structure described herein with reference to FIG. 1 and FIGS. 5 through 9.

The fluid communication between the fuel passages 20 and corresponding air passages 18 described herein results in passive modification of the fuel, forcing it to behave consistently, at least from the standpoint of fuel injection and mixing, across a broad range of fuel LHV as stated herein. This is achieved by passively mixing some air with the fuel, as needed, to keep the volumetric fuel mixture flow across the injection orifice 22 almost constant. The fuel mixture being injected is at times a pure fuel (low-LHV fuels) and at other times a rich fuel-air mixture (high-LHV fuels). Many low-LHV fuels have molecular weights similar to air due to their high N2 and/or CO content. Thus, not only is the volumetric flow held steady, but in fact also the mass flow; and therefore the momentum flux through the fuel injection orifices 22 is also held within a small variation.

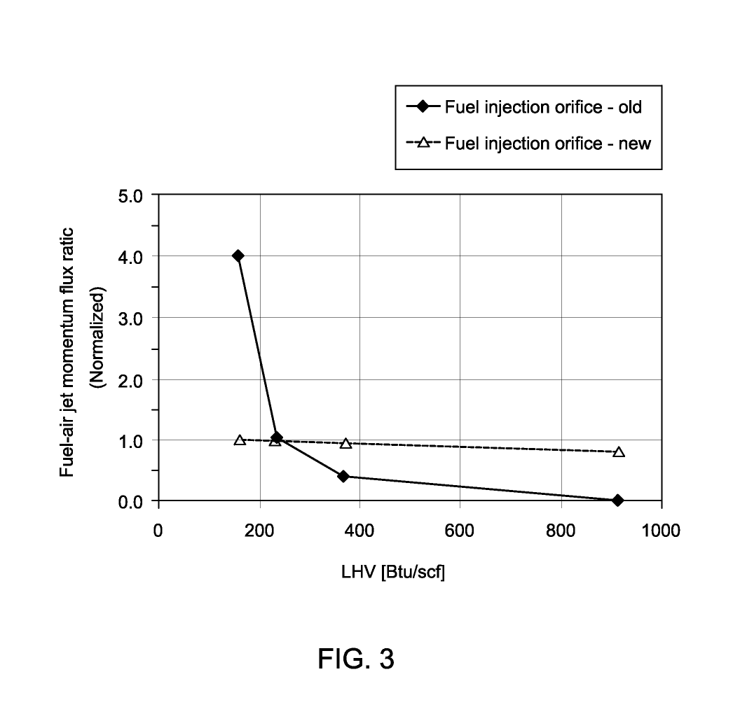

FIG. 3 is a graph illustrating the change in momentum flux ratio (momentum flux of the fuel stream, relative to the momentum flux of the air stream) through a fuel injection orifice 22 in response to changes in fuel LHV of fuel passing through the fuel injector when using a conventional fuel-air premixer versus a fuel-flexible premixer 10 according to one embodiment using the principles described herein such as that described with reference to FIG. 1.

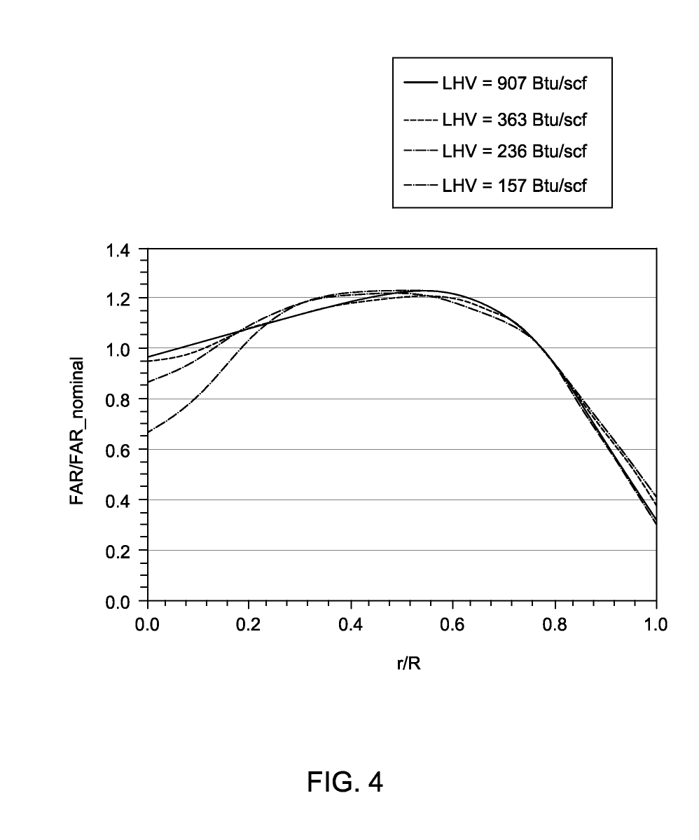

FIG. 4 is a graph illustrating the circumferentially averaged radial profile of fuel/air mixing, from experimental data using the fuel-flexible premixer 10 according to one embodiment using the principles described herein such as that described with reference to FIG. 1. The local mass ratio of fuel to air is normalized by the bulk average fuel to air ratio, so that a value of 1.0 yields perfect mixing. The fuel pressure drop and momentum flux ratio for this design behave as in FIGS. 2 and 3. It is clear that the broad range of fuels with LHV from about 150 Btu/scf to about 900 Btu/scf all achieve similar mixing performance. This mixing is achieved with limited changes in the fuel injection orifice pressure drop as illustrated in FIG. 2.

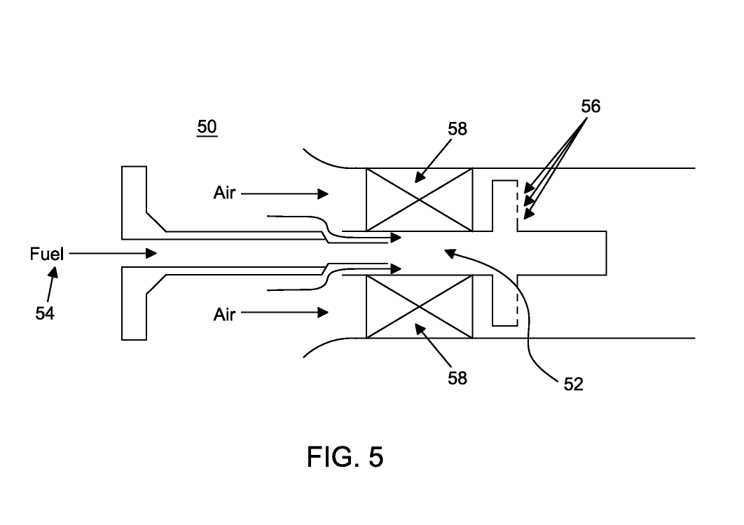

FIGS. 5, 6, 7, 8 and 9 are other embodiments of fuel-flexible premixers using the principles described herein. More specifically, FIG. 5 is a simplified diagram illustrating a fuel-flexible premixer 50 with an air-fuel mixing prechamber 52 according to another embodiment, where the fuel mixture 54 is injected through separate pegs 56 located downstream of the air swirler vanes 58.

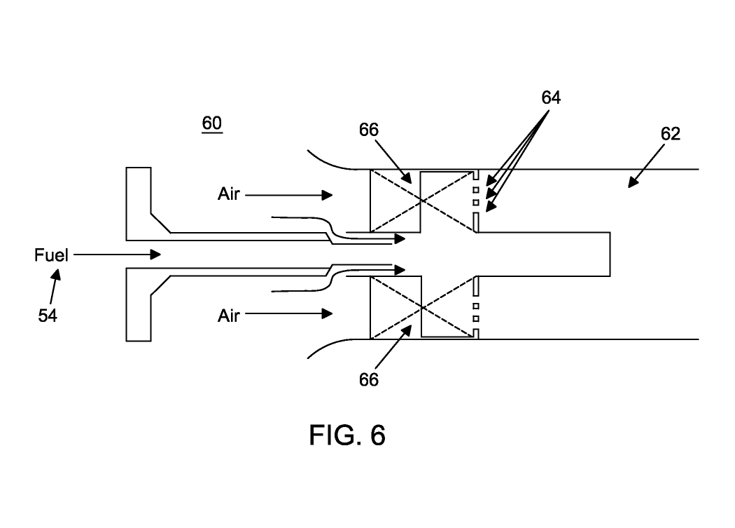

FIG. 6 is a simplified diagram illustrating a fuel-flexible premixer 60 with an air-fuel mixing prechamber 62 according to another embodiment, where the fuel mixture 54 is injected from fuel orifices 64 at the trailing edge of the air swirler vanes 66.

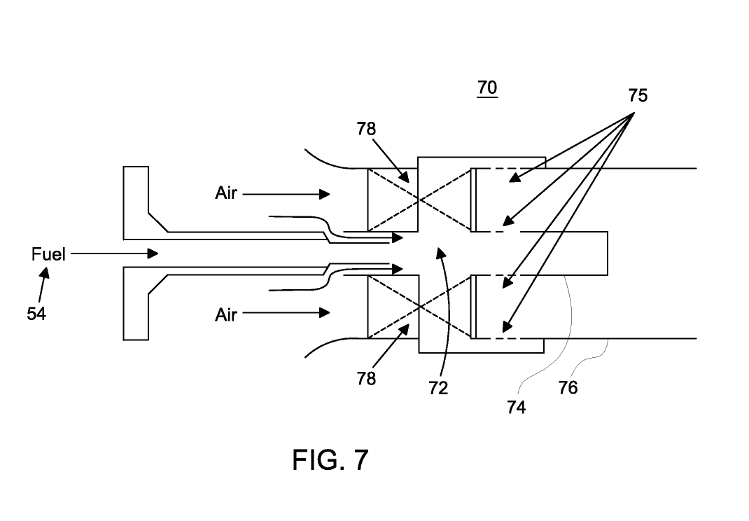

FIG. 7 is a simplified diagram illustrating a fuel-flexible premixer 70 with an air-fuel mixing prechamber 72 according to another embodiment, where the fuel mixture 54 is injected from the centerbody 74 and/or burner tube surfaces 76, downstream of the air swirler vanes 78 via a plurality of fuel orifices 75.

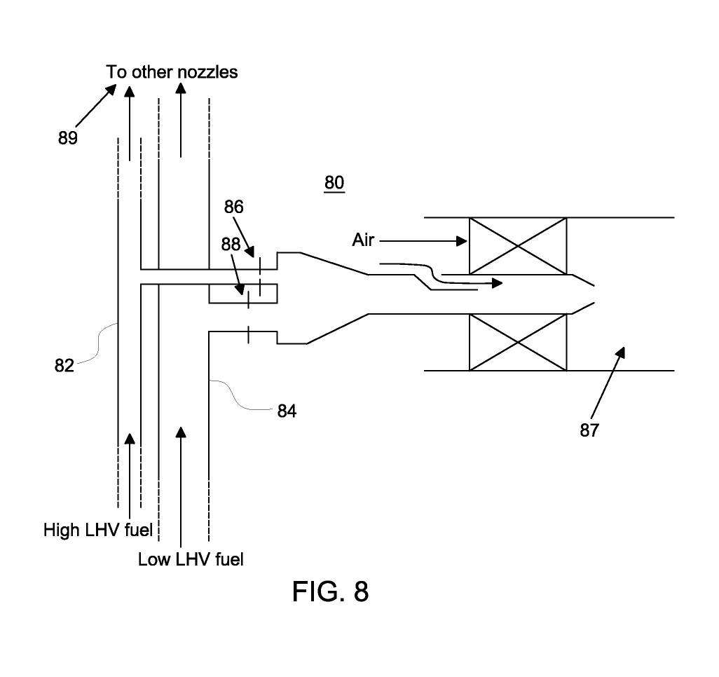

FIG. 8 is a diagram illustrating a fuel-flexible premixer 80 according to yet another embodiment. Fuel-flexible premixer 80 comprises more than one fuel plenum 82, 84 connected to the passive air-fuel mixing prechamber 87, with each plenum 82, 84 having an appropriately sized pre-orifice 86, 88 such as to cause equal fuel distribution to multiple fuel-air premixing nozzles 89 within a combustion system.

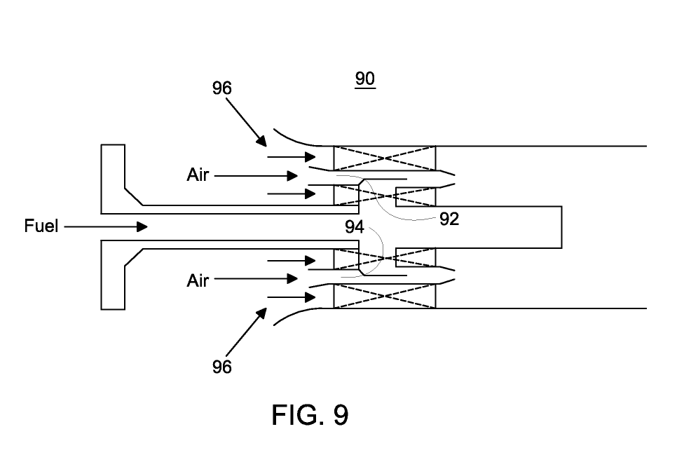

FIG. 9 is a diagram illustrating a fuel-flexible premixer 90 according to still another embodiment. Fuel-flexible premixer 90 comprises fluid conduits 92, 94 located in a stagnation region of the air flow passage 96.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A gas turbine combustion system passive air-fuel mixing prechamber comprising:
one or more fuel passages, each fuel passage comprising an upstream portion, and further comprising at least one downstream fuel injection orifice; and
one or more fluid conduits, each fluid conduit comprising a cross-sectional area connecting an upsteam fuel passage with one or more air passages, wherein the fluid conduit cross-sectional area is based upon and large enough compared to the cross-sectional areas of the corresponding fuel and air passages to create pressure drops across each connected fuel injection orifice that substantially self-equalize in a passive manner with corresponding air passage pressure drops while fuel with a wide and variable range of heating value and therefore volumetric flow rate passing through the fuel passage mixes with air passing through one or more connected fluid conduits.

2. The gas turbine combustion system prechamber according to claim 1, wherein the self-equalization occurs over a range of fuel lower heating value (LHV) from about 150 Btu/scf to about 900 Btu/scf of fuel passing through the fuel passage while mixing with air passing through one or more connected fluid conduits, wherein the range correlates with low-LHV fuels from gasification products up to natural gas.

3. The gas turbine combustion system prechamber according to claim 1, wherein the self-equalization occurs over a range of fuel lower heating value (LHV) from about 900 Btu/scf to about 3200 Btu/scf of fuel passing through the fuel passage while mixing with air passing through one or more connected fluid conduits, wherein the range correlates with high LHV fuels from natural gas up to liquified petroleum gas.

4. The gas turbine combustion system prechamber according to claim 1, wherein the self-equalization occurs over a range of fuel lower heating value (LHV) from about 800 Btu/scf to about 1200 Btu/scf of fuel passing through the fuel passage while mixing with air passing through one or more connected fluid conduits, wherein the range correlates with natural gas and liquified natural gas fuels.

5. The gas turbine combustion system prechamber according to claim 1, wherein the fuel passages, air passages, fluid conduits and fuel injection orifices are together configured such that acoustic perturbations in the combustion system affect both air and fuel flows in a substantially proportional amount, such that the fuel-to-air flow ratio remains substantially constant.

6. The gas turbine combustion system prechamber according to claim 1, wherein the one or more fuel passages and the one or more fluid conduits are configured as one portion of a gas turbine combustor fuel-air premixer comprising one or more air swirlers, turning vanes, or orifices configured to control or turn the air flowing through at least one air passage.

7. The gas turbine combustion system prechamber according to claim 6, further configured such that the pressure drops across each fuel injection orifice substantially self-equalize in a passive manner with corresponding air passage pressure drops as fuel passing through a corresponding fuel passage mixes with air passing through one or more connected fluid conduits such that pressure drops across corresponding air swirlers differ by no more than about 20% with pressure drops across the corresponding fuel injection orifices.

8. The gas turbine combustion system prechamber according to claim 1, wherein the pressure drops across each connected fuel injection orifice substantially self-equalize in a passive manner with corresponding air passage pressure drops while fuel passing through the fuel passage mixes with air passing through one or more connected fluid conduits to maintain the momentum flux of the air-fuel mixture stream through each fuel injection orifice substantially matched to the momentum flux of the air stream.

9. The gas turbine combustion system prechamber according to claim 1, wherein a fuel mixture exits the prechamber via fuel injection orifices located between two annular air passages which impart tangential velocities to the air in opposite rotational directions.

10. The gas turbine combustion system prechamber according to claim 1, wherein a fuel mixture exits the prechamber via fuel injection orifices located between two annular air passages which impart tangential velocities to the air in the same rotational direction.

11. The gas turbine combustion system prechamber according to claim 1, wherein a fuel mixture exits the prechamber via fuel injection orifices located in fuel pegs that are located downstream of an air swirler.

12. The gas turbine combustion system prechamber according to claim 1, wherein a fuel mixture exits the prechamber via fuel injection orifices located on the trailing edge of an air swirler.

13. The gas turbine combustion system prechamber according to claim 1, wherein a fuel mixture exits the prechamber via fuel injection orifices located downstream of an air swirler on the centerbody of the premixer.

14. The gas turbine combustion system prechamber according to claim 1, wherein a fuel mixture exits the prechamber via fuel injection orifices located downstream of an air swirler on the outer circumferential surface of the premixer.

15. The gas turbine combustion system prechamber according to claim 1, wherein the fuel passage is connected to two or more fuel plenums and each plenum connection has an appropriately sized orifice so as to generate a pressure drop and cause equal fuel distribution to multiple fuel premixing nozzles in a gas turbine combustion system.

16. The gas turbine combustion system prechamber according to claim 1, wherein a baffle is located in the prechamber adjacent to the fluid conduits such that fuel is substantially prevented from flowing through the fluid conduits into its corresponding air passage.

17. The gas turbine combustion system prechamber according to claim 1, wherein the fluid conduits are located in a stagnation region of a corresponding air passage, facing upstream into the oncoming air flow, such that the pressure in the fuel passage is nearly the stagnation pressure of the oncoming air flow.
